(19) United States
(12) Patent Application Publication
(10) Pub. No.: US 2025/0259127 A1
(43) Pub. Date: Aug. 14, 2025

(54) SYSTEM AND METHOD FOR IMPLEMENTING APPLICATION MODERNIZATION AND MIGRATION

(71) Applicant: KPMG LLP, New York, NY (US)

(72) Inventors: Thilina Gunarathne, Knoxville, TN (US); Daniel Domaratzky, Long Valley, NJ (US); Erik Kringen, Knoxville, TN (US); Kevin Martelli, Philadelphia, PA (US); Milinda Pathirage, Knoxville, TN (US)

(21) Appl. No.: 19/052,630

(22) Filed: Feb. 13, 2025

Related U.S. Application Data
(60) Provisional application No. 63/552,954, filed on Feb. 13, 2024.

(51) Int. Cl. G06Q 10/0637; G06Q 10/0633; G06Q 10/0635

(52) U.S. Cl. CPC G06Q 10/0637; G06Q 10/0633; G06Q 10/0635

(57) ABSTRACT

The invention relates to computer-implemented systems and methods for implementing an application modernization and migration tool. The invention provides: initiating a discovery of current system specifics, wherein the discovery comprises business analysis and technical analysis; based on the discovery, developing a modernization plan that prioritizes and optimizes application and system migration, wherein the modernization plan considers risk analysis and cost estimation; designing a pathway and an architecture for the modernization plan; executing the pathway and implementing the architecture to initiate a modernize and migrate process for a target system wherein the modernize and migrate process comprises one or more of: infrastructure build, data migration, rebuild, rehost, re-platform, refactor and integrations, testing and delivery; and making available operation of the modernized and migrated target system.

### CROSS-REFERENCE TO RELATED APPLICATIONS

The application claims priority to U.S. Provisional Application 63/552,954 (Attorney Docket No. 055089.0000125), filed Feb. 13, 2024, the contents of which are incorporated by reference herein in their entirety.

### FIELD OF THE INVENTION

The present invention relates to systems and methods for implementing application modernization and migration to accelerate a client's cloud journey, reduce risk and improve delivery quality.

### BACKGROUND

Generally, modernization may represent the process of transitioning an organization's applications, processes and data management to a cloud or other environment. Migrating an application may be referred to as a simple “Lift and Shift.” Modernization may involve a deep analysis of the applications and then a build of an updated system towards improved efficiencies and reduced costs.

Some enterprise clients have been working with the same technology for years, if not decades. In an effort to modernize, clients may seek to address migration in a piecemeal manner which leads to inefficiencies down the road. In other scenarios, clients may continue to work with outdated frameworks unsure how to approach modernization. Other needs may involve retiring certain systems. For example, clients may need assistance with safely retiring specific datacenters and then modernizing the overall system.

Enterprise clients may have systems that use and/or rely on custom developed applications. To address immediate needs, these clients may have integrated applications without a comprehensive plan in mind. This leads to disjointed applications that lack cooperation and consistency. Inevitably, critical applications that perform essential functions are in need of modernization and improved efficiencies. Other challenges facing enterprise clients include lack of skill or bandwidth to perform the modernization.

It would be desirable, therefore, to have a system and method that could overcome the foregoing disadvantages.

### SUMMARY

According to one embodiment, the invention relates to a computer-implemented system that implements an application modernization and migration tool. The system comprises: an interface that communicates with one or more data sources; a memory component that stores and manages data from the one or more data sources; and a computer processor coupled to the interface and the memory component and further programmed to perform the steps of: initiating an automatic discovery of current system specifics, wherein the automatic discovery comprises business analysis and technical analysis associated with the current system specifics; based on the automatic discovery, developing a modernization plan that prioritizes and optimizes application and system migration associated with the current system specifics, wherein the modernization plan considers a risk analysis and a cost estimation; designing a pathway and an architecture for the modernization plan; executing the pathway and implementing the architecture to initiate a modernize and migrate process for a target system wherein the modernize and migrate process comprises: infrastructure build, data migration, rebuild, rehost, re-platform, refactor and integrations, testing and delivery; and making available operation of the modernized and migrated target system.

According to another embodiment, the invention relates to a computer-implemented method that implements an application modernization and migration tool. The method comprises the steps of: initiating, via a computer processor, an automatic discovery of current system specifics, wherein the automatic discovery comprises business analysis and technical analysis associated with the current system specifics; based on the automatic discovery, developing, via the computer processor, a modernization plan that prioritizes and optimizes application and system migration associated with the current system specifics, wherein the modernization plan considers a risk analysis and a cost estimation; designing, via the computer processor, a pathway and an architecture for the modernization plan; executing, via the computer processor, the pathway and implementing the architecture to initiate a modernize and migrate process for a target system wherein the modernize and migrate process comprises: infrastructure build, data migration, rebuild, rehost, re-platform, refactor and integrations, testing and delivery; and making available, via the computer processor, operation of the modernized and migrated target system.

An embodiment of the present invention is directed to an end-to-end solution that reviews and analyses a client's enterprise environment including applications and programs to generate a determination for modernization and optimization by leveraging Generative AI (“Gen AI”) and/or accelerators. For example, a client may desire to migrate certain programs/applications or an entire enterprise from an on-premise instantiation to a cloud-based environment. Specific insights regarding the modernization through innovative user interfaces may be provided. Insights may include impacts on efficiency, resources, performance and/or other metrics.

An embodiment of the present invention may apply a scanning or discovery functionality to survey a current system by analyzing each application, component and/or device. In some scenarios, there may be hundreds and hundreds of applications. An embodiment of the present invention may prioritize and develop a modernization plan that identifies a specific order for migration. An embodiment of the present invention seeks to provide a deeper understanding of each application and system which leads to a more efficient and improved modernization process.

An embodiment of the present invention may use Generative AI to perform a data synthesis of the client data with modernization, migration and optimization considerations. For example, an embodiment of the present invention may provide intelligent disposition user interfaces to provide Gen AI assisted application disposition recommendations combining information about legacy applications extracted through code analysis, surveys and document ingestion with proprietary knowledge base, patterns and insights from LLMs. A Gen AI based intelligent chat bot may enable users to explore and analyze a generated knowledge base about legacy applications.

Some enterprise clients may not have the resources or knowledge to accurately and comprehensively identify all the applications that exist, relevant dependencies, subset of users, and which components need to be modernized. Lack of data, insights and development knowledge are hinderances to a successful modernization/migration. Accordingly, an embodiment of the present invention recognizes that proper analysis needs to occur prior to the modernization process.

An embodiment of the present invention is directed to an AI Intelligent Assistant that allows users to interact with the system by requesting clarification, making changes and seeking validation. This further expedites the process towards efficient use of resources.

These and other advantages will be described more fully in the following detailed description.

### BRIEF DESCRIPTION OF THE DRAWINGS

In order to facilitate a fuller understanding of the present invention, reference is now made to the attached drawings. The drawings should not be construed as limiting the present invention, but are intended only to illustrate different aspects and embodiments of the invention.

FIG. 1 is an exemplary diagram of a Modernization Workbench, according to an embodiment of the present invention.

FIG. 2 is an exemplary system diagram, according to an embodiment of the present invention.

FIG. 3 is an exemplary system diagram, according to an embodiment of the present invention.

FIG. 4 is an exemplary flow diagram, according to an embodiment of the present invention.

FIG. 5 is a representative user interface, according to an embodiment of the present invention.

FIG. 6 is a representative user interface, according to an embodiment of the present invention.

FIG. 7 is a representative user interface, according to an embodiment of the present invention.

FIG. 8 is a representative user interface, according to an embodiment of the present invention.

FIG. 9 is a representative user interface, according to an embodiment of the present invention.

FIG. 10 is a representative user interface, according to an embodiment of the present invention.

FIGS. 11A and 11B are representative user interfaces, according to an embodiment of the present invention.

### DETAILED DESCRIPTION

Exemplary embodiments of the invention will now be described in order to illustrate various features of the invention. The embodiments described herein are not intended to be limiting as to the scope of the invention, but rather are intended to provide examples of the components, use, and operation of the invention.

An embodiment of the present invention is directed to providing an Application Modernization and Migration Tool to accelerate a client's cloud journey, reduce risk and improve delivery quality. An embodiment of the present invention is directed to an integrated AI driven approach that provides a business value-approach engineered for scalability, security and speed. Cloud solutions may include: cloud/data strategy and architecture; cloud modernization and migration; cloud emerging technology; hybrid/multi cloud enablement; modern data fabric and AI; cloud/data management and optimization; cloud/data security and compliance; cloud resiliency; cloud development; advanced technology integration and cloud managed services.

An embodiment of the present invention is directed to various modernization offerings including a wide range of technology solutions and accelerators for businesses to modernize their IT landscape and stay ahead in today's rapidly changing technological environment. Modernization offerings may include services relating to legacy java/.net; mainframe; data; low-code/no-code; cloud infrastructure; and Generative AI infrastructure. An embodiment of the present invention supports repeatability and scalability; Generative AI assisted modernization through integrated chat capabilities, retrieval-augmented generation (RAG) models and external tooling; workbench portal that provides inclusive data ingestion and integration along with engineering guidelines; and automated containerization, continuous integration/continuous delivery/deployment (CI/CD), infrastructure as code; policy as code and best-in-class security.

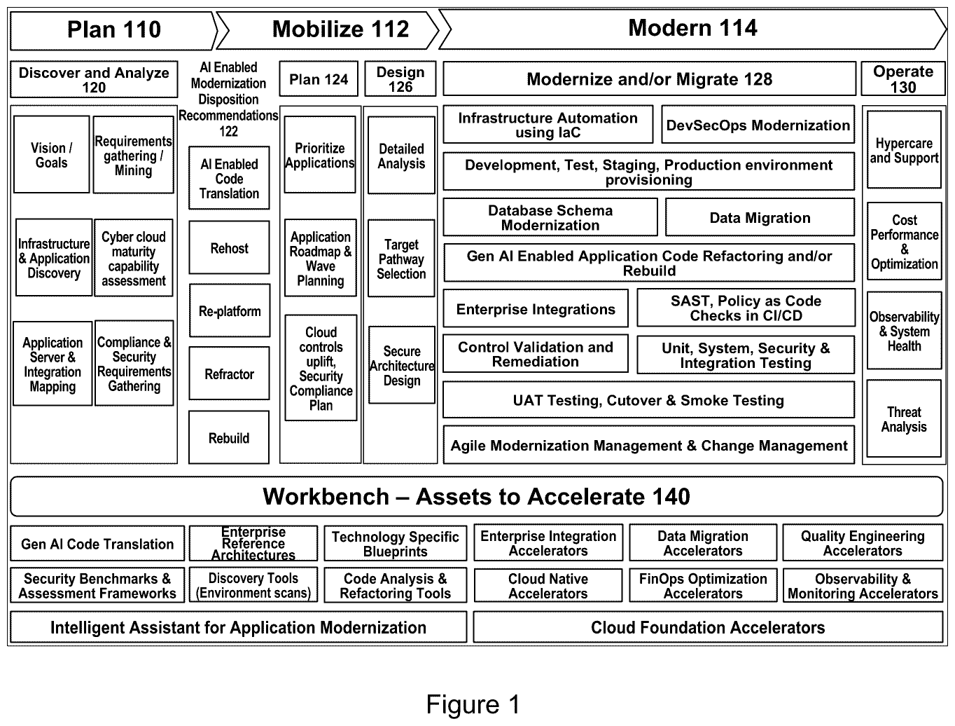

FIG. 1 is an exemplary diagram of a Modernization Workbench, according to an embodiment of the present invention. As shown in FIG. 1, various phases may be supported including Plan 110; Mobilize 112 and Modern 114. A Plan phase, represented by 110, may involve discovery and analysis 120 as well as AI enabled modernization disposition recommendations 122. A Mobilize phase, represented by 112, may involve: plan 124 and design 126. A Modern phase, represented by 128, may involve: modernize and/or migrate 128 as well as operate 130.

Discovery and Analysis 120 may focus on: vision/goals; infrastructure and application discovery; application server and integration mapping; requirements gathering/mining; cyber cloud maturity capability assessment; and compliance and security requirements gathering.

AI enabled modernization disposition recommendations 122 may involve and relate to: AI enabled code translation; rehost; re-platform; refactor and rebuild.

Plan 124 may include: prioritize applications; application roadmap and wave planning; and cloud controls uplift, security compliance plan.

Design 126 may include: detailed analysis; target pathway selection and secure architecture design.

Modernize and/or Migrate 128 may involve: infrastructure automaton using Infrastructure as code (IaC); development, security and operations (DevSecOps) modernization; development, test, staging, production environment provisioning; database schema modernization; data migration; generative AI enabled application code refactoring and/or rebuild; enterprise integrations; static application security testing (SAST)/Policy as Code Checks in CI/CD; control validation and remediation; unit, system, security and integration testing; user acceptance testing (UAT), cutover and smoke testing; and agile modernization management and change management.

Operate 130 may include: hypercare (heightened customer support and attention) and support; cost performance and optimization; observability and system health; and threat analysis.

Workbench 140 may represent assets to accelerate the modernization process. Assets may include: Generative AI code translation; enterprise reference architectures; technology specific blueprints; enterprise integration accelerators; data migration accelerators; quality engineering accelerators; security benchmarks and assessment frameworks; discovery tools (environment scans); code analysis and refactoring tools; cloud native accelerators; financial operations (FinOps) optimization accelerators; observability and monitoring accelerators; intelligent assistant for application modernization and cloud foundation accelerators.

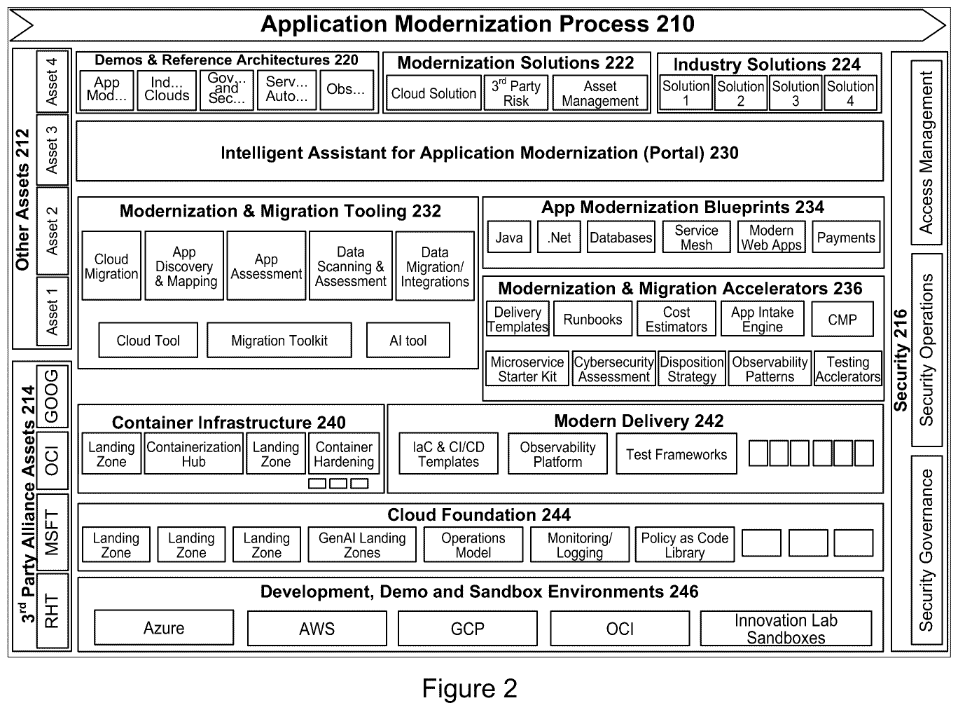

FIG. 2 is an exemplary diagram of Modernization Workbench Accelerators, according to an embodiment of the present invention. FIG. 2 illustrates an Application Modernization Process 210 with various functions including: Demos and Reference Architectures 220; Modernization Solutions 222; and Industry Solutions 224.

Demos and Reference Architectures 220 may include: App Modernization, Industry Clouds, Governance and Security, Automation, and Observability. Modernization Solutions 222 may include: SAP on Azure/AWS, third party risk; and asset management. Industry Solutions 224 may represent various solutions represented by Solutions 1, 2, 3, 4.

Intelligent Assistant for Application Modernization (Portal) 230 may communicate with Modernization and Migration Tooling 232; App Modernization Blueprints 234; Modernization and Migration Accelerators 236; Container Infrastructure 240; Modern Delivery 242; Cloud Foundation 244 and Development, Demo and Sandbox Environments 246. Other Assets 212, Third Party Assets 214 and Security 216 features may also be supported.

Modernization and Migration Tooling 232 may support Cloud Migration, Application Discovery and Mapping, Application Assessment; Data Scanning and Assessment and Data Migration/Integration along with various third party and other tools. App Modernization Blueprints 234 may include: Java, .Net, Databases, Service Mesh, Modern Web Applications, and Payments. Modernization and Migration Accelerators 236 may include: Delivery Templates, Runbooks, Cost Estimators, Application Intake Engine, cloud management platform (CMP), Microservice Starter Kit, Cybersecurity Assessment, Disposition Strategy, Observability Patterns, Testing Accelerators. Container Infrastructure 240 may include: AKS Landing Zone, Containerization Hub, EKS Landing Zone, Container Hardening along with container tools. Modern Delivery 242 may include: IaC and CI/CD Templates, Observability Platform, Test Frameworks along with various delivery tools. Cloud Foundation 244 may include: Azure Landing Zone, AWS Landing Zone, GCP Landing Zone, Gen AI Landing Zones, Operational Model, Monitoring/Logging, Policy as Code Library along with cloud tools. Development, Demo and Sandbox Environments 246 may represent Azure, AWS, GCP, OCI, Innovations Lab Sandboxes, etc.

Other Assets 212 may include internal applications, systems, platforms, etc. Third Party Assets 214 may include third party applications, systems, platforms, etc. Security 216 features may include: Security Governance, Security Operations, and Access Management.

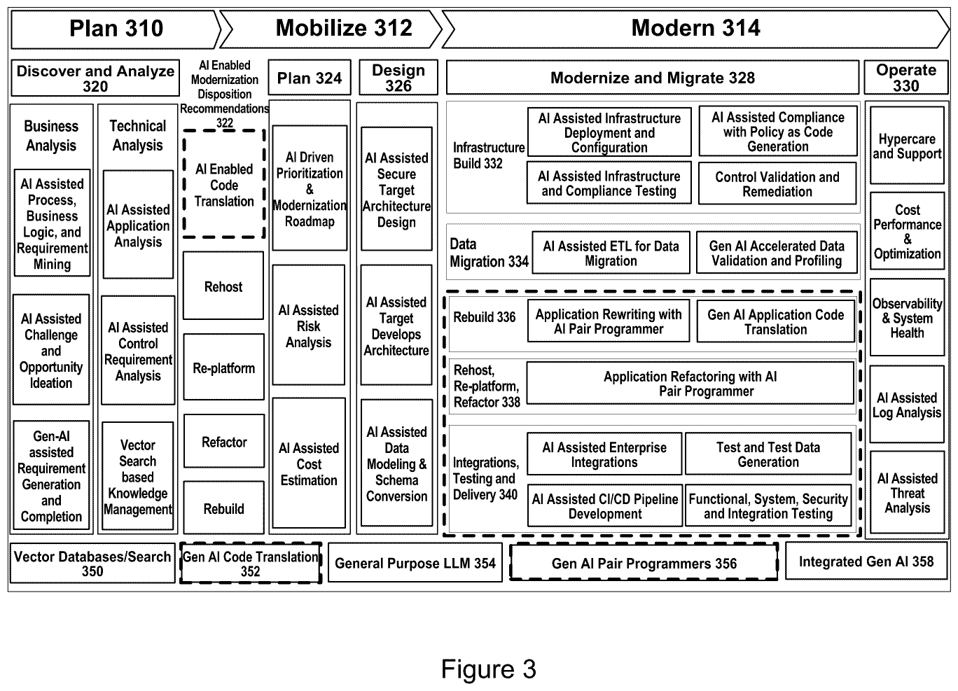

FIG. 3 is an exemplary diagram of a Gen AI Assisted Modernization Workbench, according to an embodiment of the present invention.

As shown in FIG. 3, various phases may be supported including Plan 310; Mobilize 312 and Modern 314. A Plan phase, represented by 310, may involve discovery and analysis 320 as well as AI enabled modernization disposition recommendations 322. A Mobilize phase, represented by 312, may involve: plan 324 and design 326. A Modern phase, represented by 314, may involve: modernize and/or migrate 328 as well as operate 330.

Discovery and Analysis 320 may include business analysis and technical analysis. Business analysis may include: AI assisted process, business logic, and requirement mining; AI assisted challenge and opportunity ideation; and Gen AI assisted requirement generation and completion. Technical analysis may include: AI assisted application analysis; AI assisted central requirement analysis; and vector search based knowledge management.

AI enabled modernization disposition recommendations 322 may involve and relate to: AI enabled code translation; rehost; re-platform; refactor and rebuild.

Plan 324 may include: AI driven prioritization and modernization roadmap; AI assisted risk analysis; and AI assisted cost estimation.

Design 326 may include: AI assisted secure target architecture design; AI assisted target develops architecture; and AI assisted data modeling and schema conversion.

Modernize and/Migrate 328 may involve: infrastructure build 332; data migration 334; rebuild 336; rehost/re-platform/refactor 338 and integrations, testing and delivery 340.

Infrastructure build 332 may include: AI assisted infrastructure deployment configuration; AI assisted compliance with policy as code generation; AI assisted infrastructure and compliance testing and control validation and remediation. Data migration 334 may include: AI Assisted extract, transform and load (ETL) for data migration and Gen AI accelerated data validation and profiling.

With an embodiment of the present invention, Rebuild 336 may involve: application rewriting with AI pair programmer and Gen AI application code translation. Rehost/re-platform/refactor 338 may include: application refactoring with AI pair programmer.

Integrations, testing and delivery 340 may involve: AI assisted enterprise integrations, test and test data generation, AI assisted CI/CD pipeline development and functional, system, security and integration testing.

Operate 330 may include: hypercare and support; cost performance and optimization; observability and system health; AI assisted log analysis and AI assisted threat analysis.

Additional assets to accelerate the modernization process may include: vector databases/search 350; Gen AI code translation 352; general purpose LLM 354; Gen AI pair programmers 356 and integrated Gen AI 358.

An embodiment of the present invention is directed to unifying and accelerating an application modernization journey with an Intelligent Assistant, providing an integrated platform for application modernization accelerators. An embodiment of the present invention provides a centralized view of an entire journey, from initial planning to successful deployment. An intelligent assistant may be leveraged for improved/smarter decisions and efficient modernizations combined with Generative AI and a comprehensive knowledge base.

The Intelligent Assistant may provide Generative AI powered analysis and disposition recommendations that improve a decision-making process with comprehensive analysis of application landscape. With detailed analysis and survey, static analysis and targeted surveys may unlock hidden truths for informed modernization decisions. With Generative AI powered design and planning, an embodiment of the present invention may architect an ideal future state, guiding an application modernization journey combining Generative AI with a proprietary knowledge base. Generative AI Powered Modernization enables an intelligent assistant to provide support as an ultimate pair programmer, accelerating refactoring and rewriting with speed and insight combining blueprints and knowledge base with the power of Generative AI. In addition, an embodiment of the present invention may automatically generate code snippets and further implement and/or execute the code snippets in the modernization/optimization process.

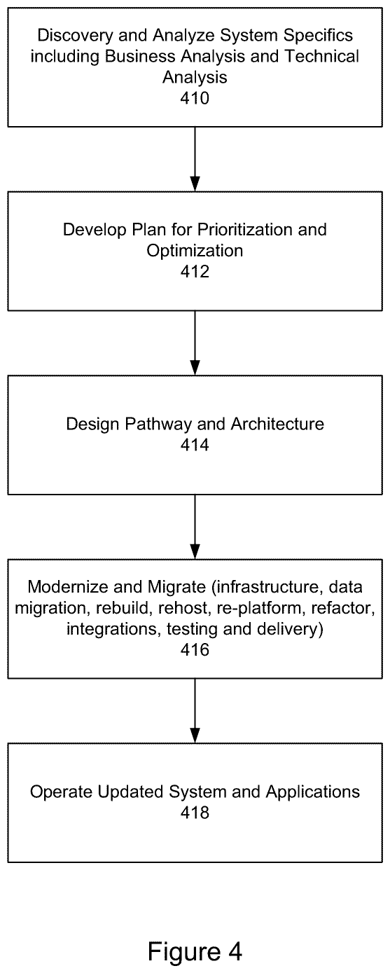

FIG. 4 is an exemplary flow diagram, according to an embodiment of the present invention. Step 410 performs discovery and analysis of system specifics including business analysis and technical analysis. An embodiment of the present invention may involve scanning an inventory of an existing environment. An embodiment of the present invention is directed to ingesting and analyzing data to develop a modernization plan. Step 412 develops a plan for prioritization and optimization. Step 414 designs pathway specifics and architecture details. Step 416 modernizes and performs a migration of details relating to infrastructure, data migration, rebuild, rehost, re-platform, refactor, integrations, testing and delivery. Step 418 operates an updated system and applications. While the process of FIG. 4 illustrates certain steps performed in a particular order, it should be understood that the embodiments of the present invention may be practiced by adding one or more steps to the processes, omitting steps within the processes and/or altering the order in which one or more steps are performed.

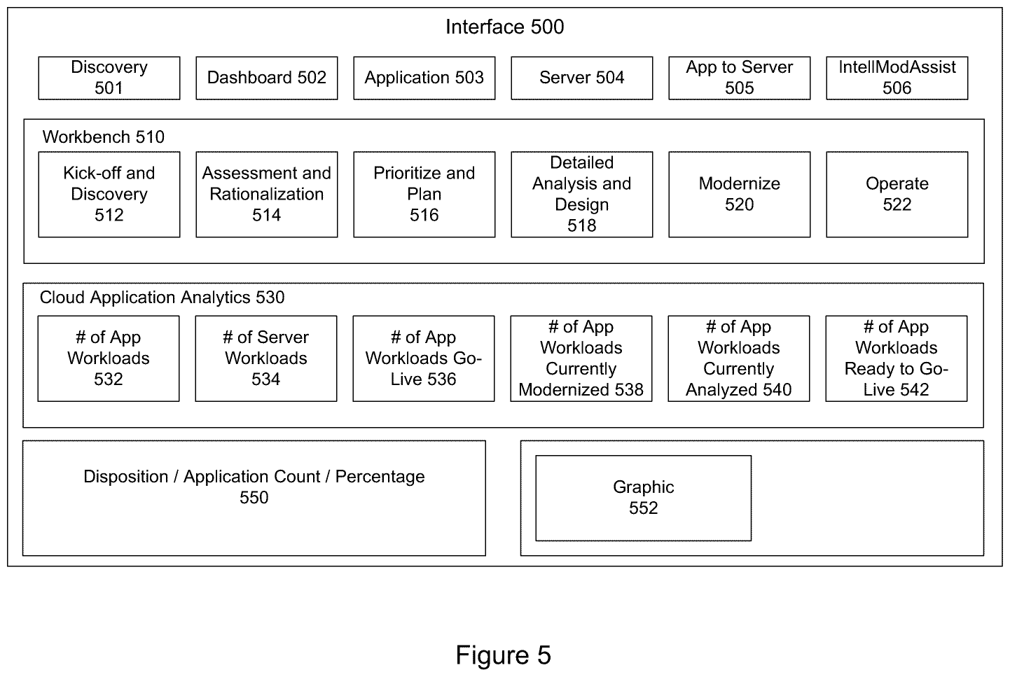

FIGS. 5-11 illustrate exemplary user interfaces, according to an embodiment of the present invention.

FIG. 5 illustrates an interface that supports a cloud modernization approach designed to systematically build and scale the value of cloud. Interface 500 may include: Discovery 501, Dashboard 502, Application 503, Server 504, Application to Server 505 and Intelligent Modernization Assistant (IntelliModAssist) 506.

Workbench Functions, shown by 510, may include kick-off and discovery 512; assessment and rationalization 514; prioritize and plan 516; detailed analysis and design 518; modernize 520; and operate 522. FIG. 5 also provides cloud applications analytics 530 including number of application workloads 532, number of server workloads 534, number of application workloads go-live 536; number of application workloads currently modernized 538; number of application workloads currently analyzed 540; and number of application workloads ready to go-live 542. Other details include disposition; application count and percentage 550 and graphic 552.

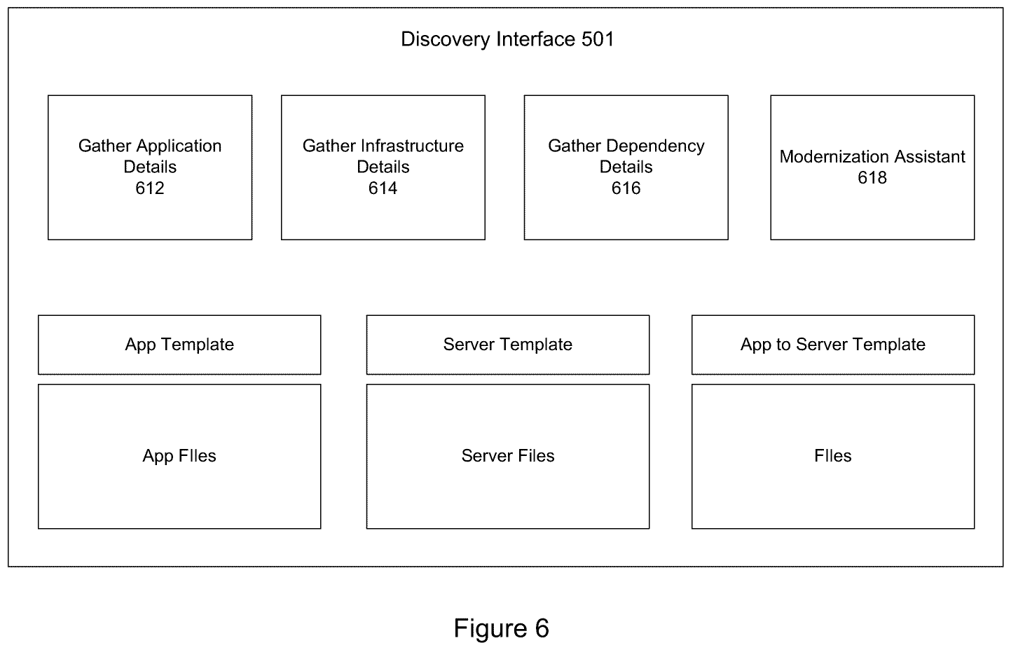

FIG. 6 illustrates a Discovery interface, according to an embodiment of the present invention. Features may include: Gather Application Details 612, Gather Infrastructure Details 614, Gather Dependency Details 616 and Modernization Assistant 618.

Gather Application Details 612 may include: agent-less or agent-based discovery, application identification, application dependencies, and application infrastructure.

Gather Infrastructure Details 614 may include: agent-ess or agent-based discovery, infrastructure inventory details and server dependencies and communication.

Gather Dependency Details 616 may include: application owner surveys, information from CMDBs and infrastructure administration surveys.

Modernization Assistant 618 may help application owners provide information about their applications to assess workloads on cloud readiness. This information may be gathered through a series of questionnaires and other tools. Discovery features may relate to Application, Server, Application to Server, etc.

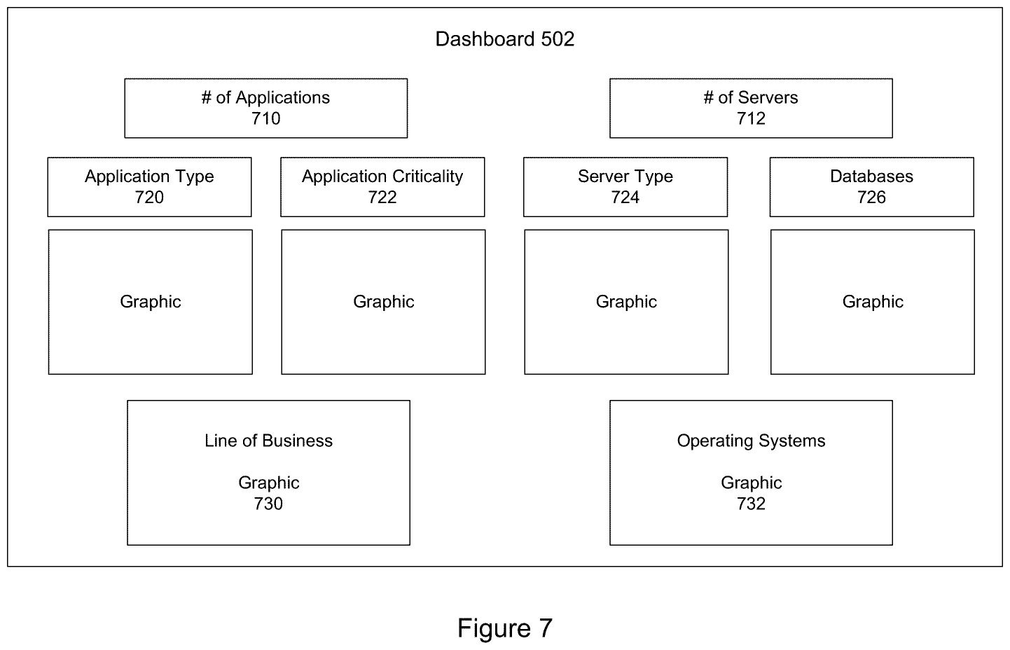

FIG. 7 illustrates a Dashboard interface, according to an embodiment of the present invention. FIG. 7 may include graphics that illustrates application and server details, including number of Applications 710 and number of Servers 712. Within Applications, other details may include: application type 720, application criticality 722, line of business 730. Within Servers, other details may include: server type 724, databases 726 and operating systems 732. Illustrations and graphics may also be provided.

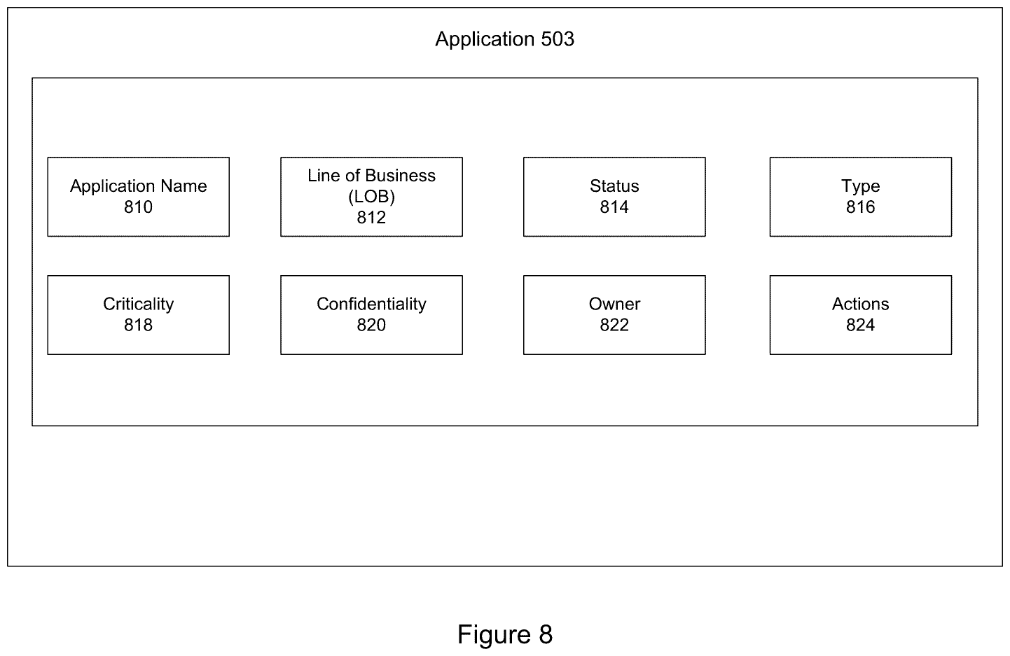

FIG. 8 illustrates an Application interface, according to an embodiment of the present invention. Application details may include: application name/identifier 810; line of business (LOB) 812; status 814; type 816; criticality 818; confidentiality 820; owner 822 and action 824.

Line of business (LOB) 812 may include categories such as retail, finance, corporate, human resources, sales, etc., Status 814 may include: active, end-of-life, inflight program, etc. Type 816 may include custom, etc. Criticality 818 may include an indicator such as high, low, medium, etc. Confidentiality 820 may include: internal, secret, confidential, restricted, etc. Owner 824 may include an individual, team leader, etc. Actions 824 may include, edit, delete, etc.

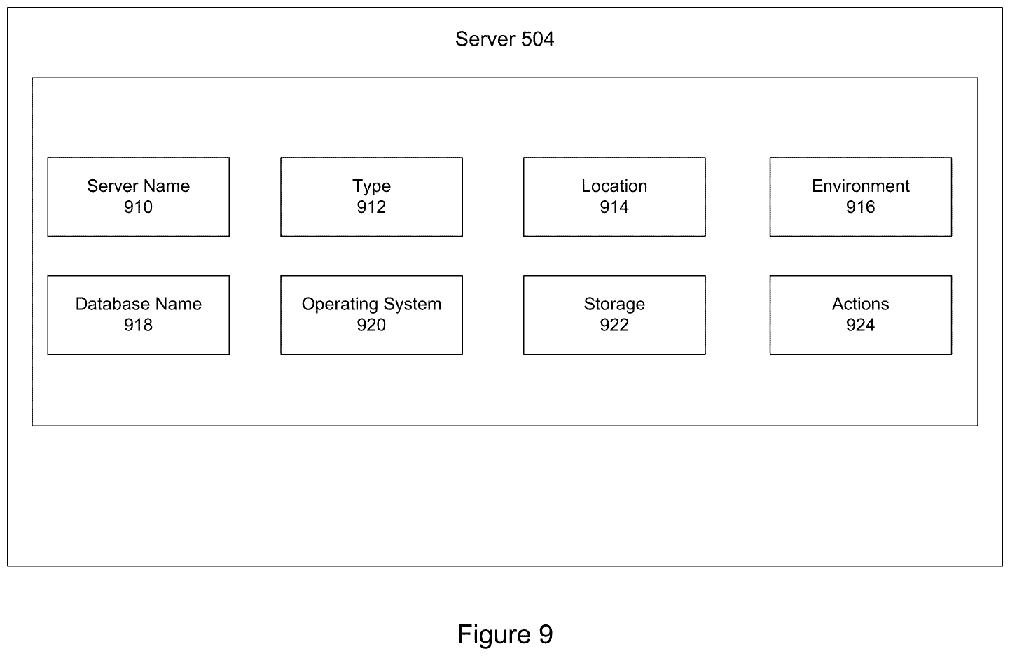

FIG. 9 illustrates a Server interface, according to an embodiment of the present invention. Server details may include: server name/identifier 910; type 912; location 914; environment 916; database (DB) name 918; operating system (OS) 920; storage 922 and actions 924.

Type 912 may include: virtual “V”, physical “P”. Location 914 may include a data center location including region, city or other geographic area. Environment 916 may include development, production, quality assurance, etc. Database (DB) name 918 may include: SQL server, Postgres server, mySQL server, etc. Operating system (OS) 920 may include: a specific version/name of an operating system. Storage 922 may include storage identifiers. Actions 924 may include, edit, delete, etc.

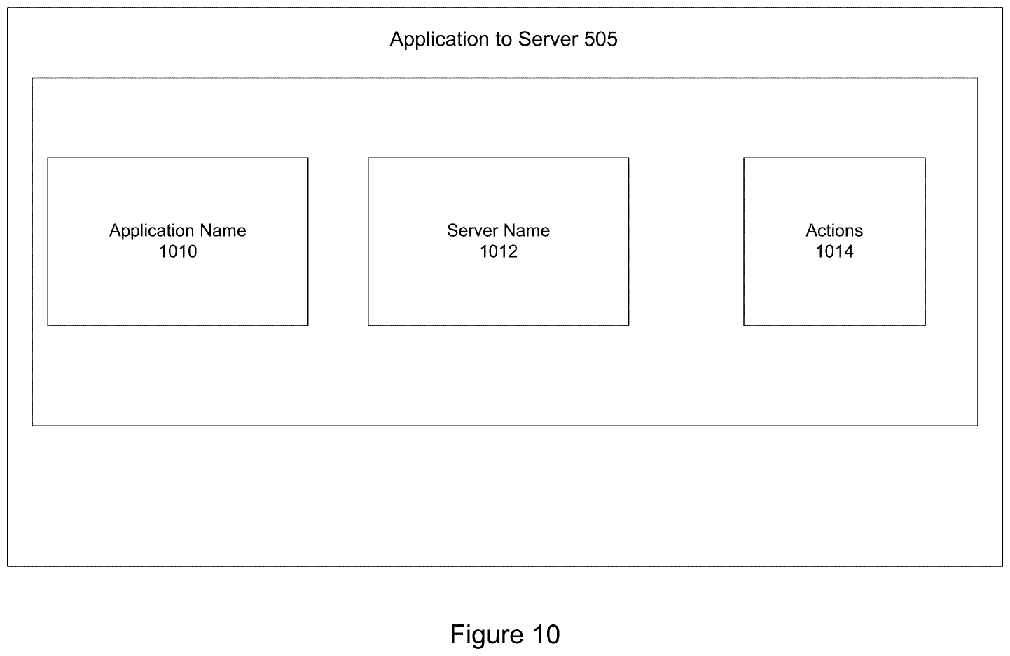

FIG. 10 illustrates an Application to Server interface, according to an embodiment of the present invention. Application to Server details may include: application name/identifier 1010; server name/identifier 1012 and actions 1014.

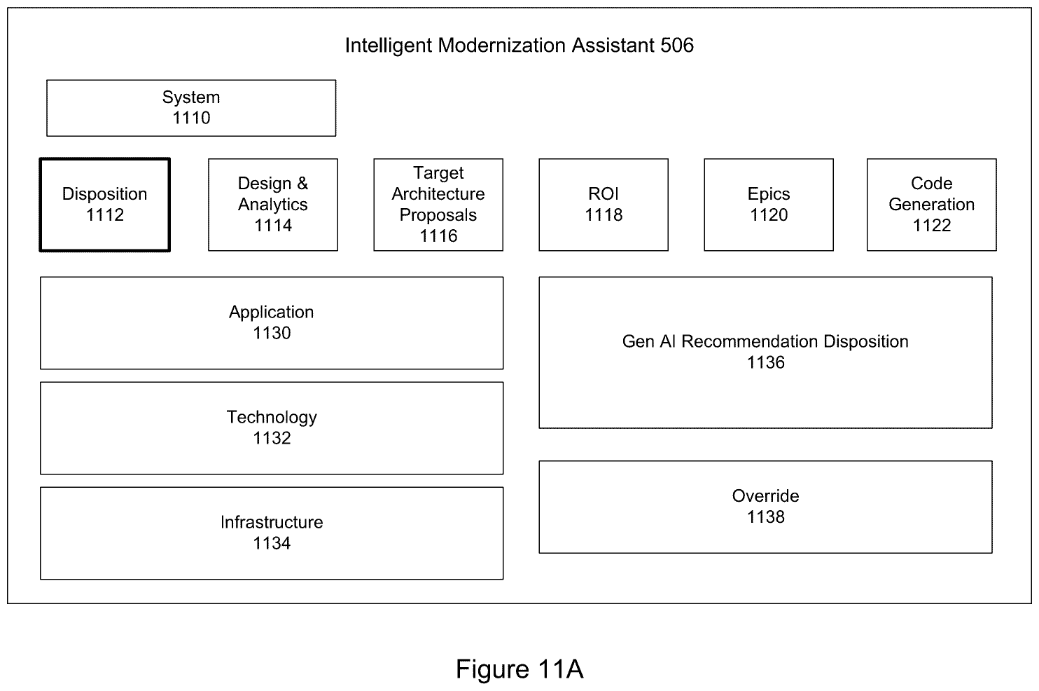

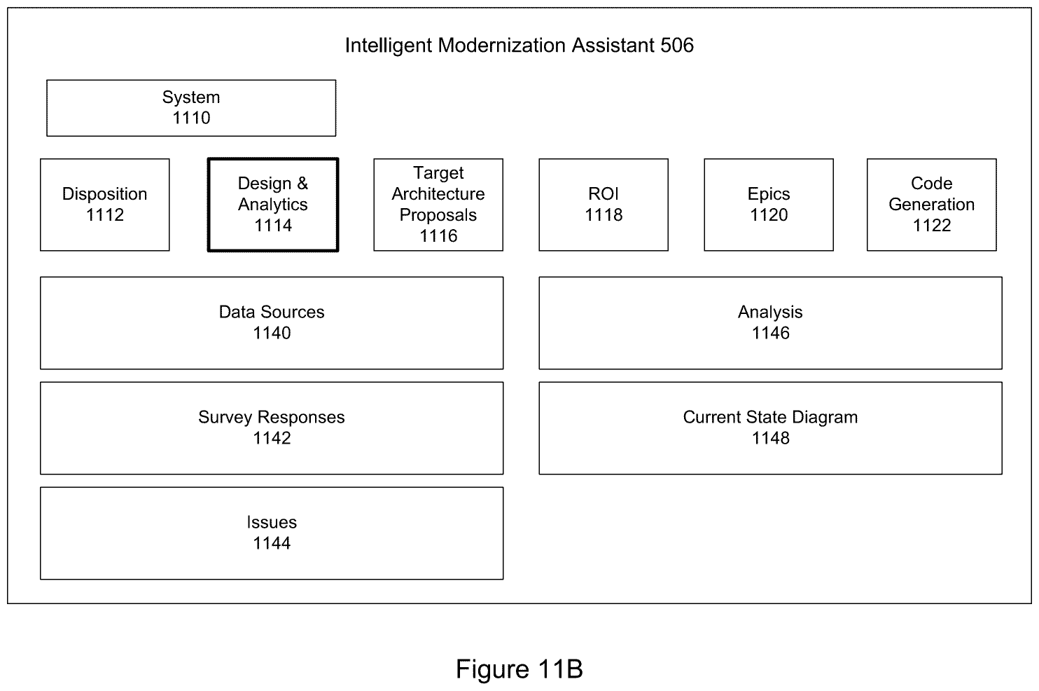

FIGS. 11A and 11B illustrate an AI Assistant interface, according to an embodiment of the present invention. Various systems may be identified at 1110 including: Inventory Reporting System, Back-Office Processing System, Human Resources Program, Sales Order System, Order Management System, Finance Data Reporting, Accounting and Reports System, Documents and Records Management System, Sales Reporting Platform and Inventory Management System, etc. As shown in FIG. 11A, details may include: Disposition 1112; Design & Analysis 1114; Target Architecture Proposals 1116; return on investment (ROI) 1118; Epics 1120; and Code Generation 1122. In addition, a high level roadmap with detailed migration information may be provided.

As shown in FIG. 11A, Disposition 1112 may include Application 1130 (e.g., criticality, status, availability requirements, recovery time objective (RTO), recovery point objective (RPO), etc.), Technology 1132 (e.g., application type, architecture type, programming languages, technical components, etc.) and Infrastructure 1134 (e.g., operating system, database, etc.). Gen AI Recommendations may also be presented at 1136 and Justifications for override at 1138.

As shown in FIG. 11A, an intelligent disposition UI may provide Gen AI Assisted application disposition recommendations combining information about the legacy application extracted through code analysis, surveys and document ingestion with a knowledge base, patterns and knowledge from an LLM. For example, a Gen AI Recommendation Disposition 1136 may generate a Refactor disposition, e.g., “Since the application has source code access and is a candidate for container or platform as a service, it is recommended to refactor the application to make it cloud-native. This will involve making changes to the application's architecture and code to take advantage of cloud-native features and services, such as containerization, auto-scaling, and cloud databases. Refactoring will ensure that the application is optimized for the cloud and can take full advantage of the benefits of cloud computing.” An Override Disposition 1138 may be provided where a disposition may be selected (e.g., Rehost”) and a justification for override may be an input (e.g., it is not a critical app and internal usage only).

Various Gen AI interaction options may be available. For example, Gen AI based intelligent chat bot may be used to explore generated knowledge base about the legacy application.

As shown in FIG. 11B, Design & Analysis 1114 may include Data Sources 1140, Survey Responses 1142, Issues 1144, Analysis 1146 and Current State Diagram 1148.

Data Sources 1140 provides an ability to ingest and extract information from documentation, architecture diagrams, etc. An embodiment of the present invention is directed to assisting organizations safely and predictably modernize applications to new technologies. Users may gain insight to the landscape through scanning options, questionnaires and/or other interactions.

Survey Responses 1142 provides an ability to collect and synthesize information through surveys and/or other interactions to collect the non-functional requirements about legacy applications. This may relate to various sections including application architecture and application cross-cutting concerns. Questions may include: how resilient is the application, how well does it recover from outages and restarts. Answers may include: application cannot be restarted cleanly after failure, requires manual intervention.

Issues 1144 provides an ability to use analyzed code from legacy systems and identify issues and opportunities for modernization. This may include: identifying an issue (e.g., password found in configuration file), category (e.g., potential), effort (e.g., number scale) and links.

Analysis 1146 provides an ability to analyze and synthesize collected information to identify technical debt (e.g., monolithic architecture with tightly coupled components, etc.) and opportunities to modernize (e.g., refactor the monolithic application into microservices to improve scalability and maintainability, etc.) and further generate architecture diagrams for the legacy applications.

Current State Diagram 1148 may include a graphic or illustration that identifies an application (e.g., customer management, etc.) and what is runs on (e.g., server, operating system, etc.), uses (e.g., database server, SQL server, etc.) and depends on (e.g., dependent application, member management system, etc.).

Target Architecture Proposals 1116 may include details relating to Service, Description, Technical Modernization, Pros, Cons, etc. For example, target platform details may include: application modernization; database modernization; and DevOps, security and monitoring modernization. In addition, Target Architecture Proposals 1116 may include details relating to Target State and Component Target State. Target State may include: Target Platform, Generate Target Architecture, Generate ROI, Epics and Code. Application Modernization pattern may include concept diagrams, physical diagrams as well as other graphics and illustrations. An exemplary architecture diagram may include details relating to version control layer, security layer, monitoring layer as well as components such as Development Operations (DevOps), Security Center, Monitor System, Application Service, Kubernetes Service, etc.

For ROI 1118, Generative AI recommendations may include ROI benefit, description, percentage of benefit; short term, medium term and long term. ROIs may be used to support business cases. ROI information may be generated for a selected modernization option.

For Epics 1120, Generative AI recommendations may include Epic name/identifier, story name, story description and priority. Epics may be used to manage modernization. Epics and stories may be generated to perform and manage a selected modernization option.

Code Generation 1122 include: Application modernization, database modernization and DevOps, security and monitoring modernization. For example, an embodiment of the present invention may provide infrastructure as code deployment script generation for a selected architecture recommendation. This may include providing a script for deploying an application in a cloud environment with assumptions and generated code.

It will be appreciated by those persons skilled in the art that the various embodiments described herein are capable of broad utility and application. Accordingly, while the various embodiments are described herein in detail in relation to the exemplary embodiments, it is to be understood that this disclosure is illustrative and exemplary of the various embodiments and is made to provide an enabling disclosure. Accordingly, the disclosure is not intended to be construed to limit the embodiments or otherwise to exclude any other such embodiments, adaptations, variations, modifications and equivalent arrangements.

The foregoing descriptions provide examples of different configurations and features of embodiments of the invention. While certain nomenclature and types of applications/hardware are described, other names and application/hardware usage is possible and the nomenclature is provided by way of non-limiting examples only. Further, while particular embodiments are described, it should be appreciated that the features and functions of each embodiment may be combined in any combination as is within the capability of one skilled in the art. The figures provide additional exemplary details regarding the various embodiments.

Various exemplary methods are provided by way of example herein. The methods described can be executed or otherwise performed by one or a combination of various systems and modules.

The use of the term computer system in the present disclosure can relate to a single computer or multiple computers. In various embodiments, the multiple computers can be networked. The networking can be any type of network, including, but not limited to, wired and wireless networks, a local-area network, a wide-area network, and the Internet.

According to exemplary embodiments, the System software may be implemented as one or more computer program products, for example, one or more modules of computer program instructions encoded on a computer-readable medium for execution by, or to control the operation of, data processing apparatus. The implementations can include single or distributed processing of algorithms. The computer-readable medium can be a machine-readable storage device, a machine-readable storage substrate, a memory device, or a combination of one or more them. The term “processor” encompasses all apparatus, devices, and machines for processing data, including by way of example a programmable processor, a computer, or multiple processors or computers. The apparatus can include, in addition to hardware, software code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed for execution on one computer or on multiple computers that are located at one site or distributed across multiple sites and interconnected by a communications network.

A computer may encompass all apparatus, devices, and machines for processing data, including by way of example a programmable processor, a computer, or multiple processors or computers. It can include, in addition to hardware, code that creates an execution environment for the computer program in question, e.g., code that constitutes processor firmware, a protocol stack, a database management system, an operating system, or a combination of one or more of them.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computer-readable media suitable for storing computer program instructions and data can include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While the embodiments have been particularly shown and described within the framework for conducting analysis, it will be appreciated that variations and modifications may be affected by a person skilled in the art without departing from the scope of the various embodiments. Furthermore, one skilled in the art will recognize that such processes and systems do not need to be restricted to the specific embodiments described herein. Other embodiments, combinations of the present embodiments, and uses and advantages of the will be apparent to those skilled in the art from consideration of the specification and practice of the embodiments disclosed herein. The specification and examples should be considered exemplary.

What is claimed is:

1. A computer-implemented system for implementing an application modernization and migration tool, the system comprising:
an interface that communicates with one or more data sources;
a memory component that stores and manages data from the one or more data sources; and
a computer processor coupled to the interface and the memory component and further programmed to perform the steps of:
initiating an automatic discovery of current system specifics, wherein the automatic discovery comprises business analysis and technical analysis associated with the current system specifics;
based on the automatic discovery, developing a modernization plan that prioritizes and optimizes application and system migration associated with the current system specifics, wherein the modernization plan considers a risk analysis and a cost estimation;
designing a pathway and an architecture for the modernization plan;
executing the pathway and implementing the architecture to initiate a modernize and migrate process for a target system wherein the modernize and migrate process comprises: infrastructure build, data migration, rebuild, rehost, re-platform, refactor and integrations, testing and delivery; and
making available operation of the modernized and migrated target system.

2. The computer-implemented system of claim 1, wherein the business analysis comprises: process, business logic and requirement mining; challenge and opportunity ideation; and requirement generation and completion.

3. The computer-implemented system of claim 1, wherein the technical analysis comprises: application analysis; control requirement analysis and knowledge management.

4. The computer-implemented system of claim 1, wherein the infrastructure build comprises: infrastructure deployment and configuration; compliance with policy as code generation; infrastructure and compliance testing and control validation and remediation.

5. The computer-implemented system of claim 1, wherein the data migration comprises: extract, transform and load (ETL) for data migration and accelerated data validation and profiling.

6. The computer-implemented system of claim 1, wherein the rebuild comprises: application rewriting with AI pair programmer and Generative AI application code translation.

7. The computer-implemented system of claim 1, wherein the rehost, re-platform, refactor comprises: application refactoring with AI pair programmer.

8. The computer-implemented system of claim 1, wherein the integrations, testing and delivery comprises: enterprise integrations; test and test data generation; continuous integration (CI)/continuous deployment (CD) pipeline development; functional, system, security and integration testing.

9. The computer-implemented system of claim 1, wherein the interface communicates via a communication network and displays cloud application analytics for the modernize and migrate process.

10. The computer-implemented system of claim 9, wherein the cloud application analytics comprises: number of application workloads, number of server workloads, number of application workloads go-live, number of application workloads currently modernized, number of application workloads currently analyzed and number of workloads ready to go-live.

11. A computer-implemented method for implementing an application modernization and migration tool, the method comprising the steps of:
initiating, via a computer processor, an automatic discovery of current system specifics, wherein the automatic discovery comprises business analysis and technical analysis associated with the current system specifics;
based on the automatic discovery, developing, via the computer processor, a modernization plan that prioritizes and optimizes application and system migration associated with the current system specifics, wherein the modernization plan considers a risk analysis and a cost estimation;
designing, via the computer processor, a pathway and an architecture for the modernization plan;
executing, via the computer processor, the pathway and implementing the architecture to initiate a modernize and migrate process for a target system wherein the modernize and migrate process comprises: infrastructure build, data migration, rebuild, rehost, re-platform, refactor and integrations, testing and delivery; and
making available, via the computer processor, operation of the modernized and migrated target system.

12. The computer-implemented method of claim 11, wherein the business analysis comprises: process, business logic and requirement mining; challenge and opportunity ideation; and requirement generation and completion.

13. The computer-implemented method of claim 11, wherein the technical analysis comprises: application analysis; control requirement analysis and knowledge management.

14. The computer-implemented method of claim 11, wherein the infrastructure build comprises: infrastructure deployment and configuration; compliance with policy as code generation; infrastructure and compliance testing and control validation and remediation.

15. The computer-implemented method of claim 11, wherein the data migration comprises: extract, transform and load (ETL) for data migration and accelerated data validation and profiling.

16. The computer-implemented method of claim 11, wherein the rebuild comprises: application rewriting with AI pair programmer and Generative AI application code translation.

17. The computer-implemented method of claim 11, wherein the rehost, re-platform, refactor comprises: application refactoring with AI pair programmer.

18. The computer-implemented method of claim 11, wherein the integrations, testing and delivery comprises: enterprise integrations; test and test data generation; continuous integration (CI)/continuous deployment (CD) pipeline development; functional, system, security and integration testing.

19. The computer-implemented method of claim 11, further comprising the step of:
displaying, via an interface, cloud application analytics for the modernize and migrate process.

20. The computer-implemented method of claim 19, wherein the cloud application analytics comprises: number of application workloads, number of server workloads, number of application workloads go-live, number of application workloads currently modernized, number of application workloads currently analyzed and number of workloads ready to go-live.
